(19) United States
(12) Patent Application Publication
(10) Pub. No.: US 2005/0069072 A1
(43) Pub. Date: Mar. 31, 2005

(54) Production of energy and materials by nuclear synthesis

(76) Inventors: Borys Vasylyevych Bolotov, Kyiv (UA); Nelly Andreevna Bolotova, Kyiv (UA); Maxym Borysovych Bolotov, Kyiv (UA)

Correspondence Address: Daniel D Bucca;McDermott Will & Emery, 600 13th Street N W, Washington, DC, 20005-3096, US

(21) Appl. No.: 10/494,757

(22) PCT Filed: Nov. 5, 2002
(86) PCT No.: PCT/AU02/01498

(30) Foreign Application Priority Data
Nov. 5, 2001 (AU) PR 8678

(51) Int. Cl. G21J 1/00; G21B 1/00

(52) U.S. Cl. 376/100

(57) ABSTRACT

A process for producing energy and elemental material by a nuclear synthesis reaction, includes introducing into an electrolysis cell (EC) a metal salt and a solid electrolyte (14) which can be heated to a molten state. The electrolyte is then electrolysed to melt the same and to heat the metal salt such that atoms thereof synthesise to produce the elemental material and thereby generate energy. The process makes use of current generator (CG) that provides current to the electrolysis cell to electrolyse and melt the electrolyte and to heat the metal salt.

### FIELD OF INVENTION

The present invention relates to a process and apparatus for producing energy and elemental material by a nuclear synthesis of elements, in particular from those in the mid-range of the periodic table of elements.

### BACKGROUND TO THE INVENTION

The consumption of electricity and other forms of energy throughout the world is increasing at a rapid rate. Presently, the bulk of world energy supply comes from the burning of fossil fuels, producing large amounts of carbon dioxide and other green house gases. Whilst the burning of fossil fuels to produce energy is widely recognised as a major cause of the green house effect, available substitutes are unreliable or economically not yet viable (eg. wind, hydroelectricity and solar power) or are dangerous (eg. nuclear fission).

Sources of energy such as wind and solar power are not yet economically competitive with fossil fuel combustion and are also weather dependant. Hydro-electric power production is not reliable on its own, being entirely weather dependant. These alternative power sources are not yet seriously considered as capable of substituting fossil fuels.

Nuclear fission of heavy elements such as Uranium 235 is currently in use, but finds much public disapproval. This is because of the risk of nuclear explosion and the problems associated with the disposal of the fuel residue.

Nuclear fusion has been researched for many years and postulated as a cleaner and safer alternative to nuclear fission. In theory, nuclear fusion of hydrogen (typically its isotopes deuterium or tritium) could solve the problem of reliance on fossil fuel combustion. Hydrogen is, in effect, a limitless source of fuel (from water). The reaction products are non-polluting, and the fusion reaction can be operated so that there is virtually no risk of explosion (ie. the reaction allegedly stops as soon as the plasma field in which the reaction takes place ceases).

However, the most significant hurdle to controlled nuclear fusion has been the preliminary findings that the energy required to maintain a hot plasma field for fusion is greater than the energy produced by the process. This is in part attributable to the very high temperatures required for the plasma generation.

### SUMMARY OF THE INVENTION

In a first aspect, the present invention provides a process for producing energy and elemental material by a nuclear synthesis reaction, including the steps of:
(i) introducing into an electrolysis cell a metal salt and a solid electrolyte which can be heated to a molten state; and
(ii) electrolysing the electrolyte to melt the same and to heat the metal salt such that atoms thereof synthesise to produce the elemental material and thereby generate energy.

The present inventors have surprisingly discovered that salts of metals such as lithium, sodium, calcium and zirconium (and other metals from the mid-range of the periodic table) can, under certain conditions, react at a nuclear level and transform or combine into various other elements, releasing large amounts of energy in the process. The metal salt and electrolyte can also be selected such that the other elements produced can be valuable (eg. rare metals such as gold, platinum etc). The term “elemental material” refers to the production by nuclear synthesis of new elements, and can include pure forms and salts etc of those new elements.

The lithium, sodium, calcium and zirconium metals have been successfully reacted in a cryolite electrolyte, however the present inventors surmise that other metals can be reacted in cryolite or different electrolytes. The metal salt is thus a primary “fuel” for the process.

Preferably the metal salt is a metal fluoride salt. In this regard, it is preferred that fluoride salts of lithium, sodium, calcium and zirconium are employed in the process. Metal fluoride salts are preferred because they are highly electrically active in the molten electrolyte.

Preferably for lithium, sodium, calcium and zirconium fluorides the electrolyte is cryolite (Na₃AlF₆), however, other solid electrolytes can be used for these and other metals, such as BaO, SeO, PbO, TaO, HgO electrolytes etc.

Preferably an electron stimulant is also fed to the cell. Preferably the electron stimulant is a metal oxide, nitride or sulphide. Preferably for lithium, sodium, calcium and zirconium fluorides the metal oxide is one or both of an aluminium or zirconium oxide, and the metal nitrides or sulphides are one or more nitrides/sulphides of titanium, copper, iron, lead or other metals. The metal oxide, nitride or sulphide is added to stimulate electron activity up to and during the synthesis step and can also be consumed in the process (ie. acting also as a fuel).

Preferably the current supplied to the electrolysis has an asymmetric configuration. Typically the electrolyte is selected to be electrically non-linear, in that the resistance of the bath varies non-linearly with changes in electrolysis voltage. Advantageously, because of the asymmetrical nature of the current and the non-linear nature of the electrolyte, the current flow within the electrolysis circuit is essentially direct. The inventors have discovered that elemental metals produced in the process then deposit on the cathode, minimising or eliminating any wear/consumption thereof.

Preferably the asymmetric current is produced in a power circuit incorporating a variable saturation inductor. Such current has been observed to produce sufficient heat/energy at the anode of an electrolytic cell such that nuclear synthesis can take place.

Preferably the variable saturation inductor includes a direct current source which in some embodiments can be varied to vary the inductor output. The variable saturation inductor can also ensure that only direct current is supplied to the electrolysis process.

As an option, the electrolysis can be conducted using multi-phase stimulation, such as a magnetic phase stimulation. For example, two or three phase stimulation of the electrolytic cell can increase the rate of nuclear synthesis. In addition phases beyond three (ie. n-phase stimulation) can be employed.

Preferably the multi-phase stimulation employs a magnetic field around the electrolysis cell and makes use of the Hall effect.

Preferably the energy produced by the process is at least in part used to heat a fluid, the fluid being used for subsequent energy generation (such as driving a power turbine).

In a second aspect, the present invention provides apparatus for producing energy and elemental material by a nuclear synthesis reaction, including;
(i) an electrolysis cell in which a metal salt can be introduced and a solid electrolyte can be heated to a molten state; and
(ii) a current generator for providing an asymmetric current to the electrolysis cell to electrolyse and melt the electrolyte and to heat the metal salt such that atoms thereof can synthesise to produce the elemental material and thereby generate energy.

In a third aspect the present invention provides apparatus for producing energy and elemental material by a nuclear synthesis reaction, including:
(i) an electrolysis cell in which a metal salt can be introduced and a solid electrolyte can be heated to a molten state, the cell employing electrodes which are adapted for use with a molten electrolyte and metal salt; and
(ii) a current generator for providing current to the electrolysis cell to electrolyse and melt the electrolyte and to heat the metal salt such that atoms thereof can synthesise to produce the elemental material and thereby generate energy.

Preferably electrodes of the cell include a cathode bath in which the electrolyte is held and an anode member extending into the bath. Preferably the anode and cathode are formed from graphite, nickel-chromium, pure iron or other suitable material. In one variation, instead of introducing the metal salt as a reagent (fuel) into the bath, it can be incorporated or dispersed through the anode member. Thus, where the anode material is consumed, the anode can be progressively fed (eg. lowered or extended) into the cell to maintain fuel supply, thus making the process continuous.

Preferably the anode has a heat exchange coil extending therethrough, for conducting energy generated in the form of heat to a fluid in the coil in use. Preferably the cathode also has a heat exchange coil associated therewith, for conducting energy generated in the form of heat to a fluid in the coil in use. The fluid is thus heated and can be used for power generation. Preferably the fluid is water and is heated to produce steam, which can then be fed to a turbine generator.

Preferably the current generator of the second aspect employs the power circuit incorporating a variable saturation inductor of the first aspect to produce asymmetric current for the electrolysis cell.

### BRIEF DESCRIPTION OF THE DRAWING

Notwithstanding any other forms which may fall within the scope of the present invention, preferred forms of the invention will now be described, by way of example only, with reference to the accompanying drawing in which:

FIG. 1 shows a schematic depiction of apparatus for carrying out a preferred process for producing energy and elemental material according to the invention.

### MODES FOR CARRYING OUT THE INVENTION

The present inventors noted that nuclear reactions were possible with most elements in the periodic table and discovered that some of them were observable in nature. For example, one of the inventors surprisingly discovered that certain animal cells were capable of converting silicon and carbon into calcium (C₆+Si₁₄=Ca₂₀).

The inventors recognised that some of these reactions were energy negative (i.e. more energy was used to induce the reaction than was released in the process), some were energy neutral and some were energy positive.

The inventors then surprisingly discovered that some energy positive nuclear reactions were able to be induced. In their initial trials the inventors introduced fluorides of lithium, sodium, calcium and zirconium into an electrolytic bath (or oven). The metal salts ultimately selected were able to be varied depending on whether the process was to be used for energy production, elemental material production or both.

The inventors started with metal fluorides because these were known from aluminium production to provide electrically active salts. The bath was filled with molten aluminium cryolite (Na₃AlF₆) although the inventors noted that other cryolites could be employed, such as lead cryolite, tantalum cryolite, mercury cryolite etc, depending on the desired end products.

Electron stimulants were added to stimulate electron activity, in the form of oxides of aluminium or zirconium, or nitrides or sulphides of titanium, copper, iron, lead and other metals. At the same time, at the elevated temperatures generated adjacent to the anode of the electrolytic bath, the electron stimulants also acted as a secondary fuel, being consumed in the nuclear synthesis reaction.

Fluorides of lithium, sodium, potassium or calcium were also selectively added to decrease the melting temperature of the cryolite, thereby reducing the amount of energy required to melt the electrolyte.

In one example, the inventors discovered that oxygen and zirconium reacted under certain conditions at the nuclear level and were transformed (synthesised) initially into krypton and neon, then to germanium and magnesium and finally into nickel and silicon, releasing large amounts of energy in the process.

### PROCESS EXAMPLE

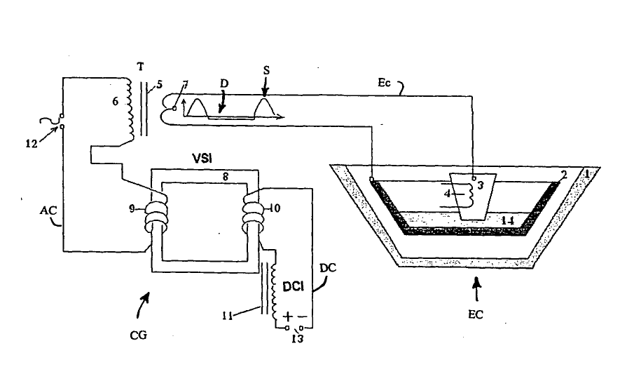

An example of a process and apparatus according to the present invention using an electrolytic bath will now be described with reference to FIG. 1. In FIG. 1 VSI symbolises a variable saturation inductor, T a transformer and DCI a direct current inductor.

The process and apparatus depicted in FIG. 1 included a current generator CG and an electrolysis cell EC. The electrolysis cell EC included a bath housing 1 having a heat exchange device associated therewith (typically a coil extending therethrough and conveying a fluid such as water (not shown)). The fluid acted as a coolant for the cell but also received heat energy produced by the process and thus was able to be used for subsequent power generation. When water was used, steam (eg. superheated steam) was produced and this was able to be fed to a steam turbine for electricity generation.

The cell included a bath 2 supported in the housing 1, the bath holding an electrolyte 14 and also operating as the cathode of the cell. The bath was typically lined with graphite, nickel-chromium, pure iron or other suitable high-temperature electrode material. The cell further included an anode member 3 extending into the bath 2 and having a heat exchange coil 4 extending therethrough for extracting heat from the anode 3. As with the cathode, the anode was typically formed from graphite, nickel-chromium, pure iron or other suitable high-temperature electrode material.

As described for the cathode, the coil 4 had fluid (eg water heatable to steam) passing therein which was able to be used for subsequent electricity production.

The current generator CG included an electrical transformer 5 having a primary winding 6 and a secondary winding 7, symbolised overall as T. The transformer T was coupled to a variable saturation inductor VSI to control the current fed to the electrolysis process. The current generator was designed to produce an asymmetric direct type of current (as depicted by the diagram D in FIG. 1).

The variable saturation inductor included an inductor coil 8, an operating winding 9 as part of an AC circuit, and a direct-current winding 10 as part of a DC circuit. The DC circuit further included a direct current inductor 11, symbolised overall as DCI, for smoothing any irregularities in the direct-current in circuit DC (ie. as a result of the generation of current spikes resulting from the influence of windings 9).

In the AC circuit an AC power source 12 connected to a mains power supply was provided. In the DC circuit a DC power source (eg. battery) 13 was provided. The voltage of the source 13 could typically be varied.

The positive component of AC power provided from source 12 was supplemented by power from the variable saturation inductor, whilst the negative component of the AC power was cancelled out (eliminated) by the VSI. This had the effect of producing and supplying, via the transformer T, an asymmetric direct power supply (diagram D) to the electrolysis cell.

The current induced in electrolysis circuit Ec was thus able to be regulated. For example, the positive current component (or spike S) was able to be varied (either increased or decreased) and, in addition, a series of phase shifted current spikes (described below) were also able to be produced. Controlling the direct current supplied to the electrolysis cell in this manner enabled the generation of very high temperatures in the region of contact of anode 3 with electrolyte 14. These temperatures were easily high enough to maintain as molten a solid electrolyte held in bath 2, and were sufficient to enable certain metal salts in the electrolyte/anode to synthesise at the nuclear level into other elements, thereby releasing energy.

Current Generation

One preferred current generation process was as follows. Asymmetric current from winding 7 was supplied to the electrodes 2 and 3. The asymmetric current was produced by the saturation induction of mains power supply circuit AC. In this regard, the variable saturation inductor VSI was supplied with direct current from the source 13 via winding 10. Inductor 11 was used to remove/prevent any variation in the DC current from source 12 (ie. to remove/prevent any spikes). The source 13 was capable of regulating the current by either selectively increasing or decreasing such current.

Typically electrolyte 14 was melted by an external heat source, prior to the passing of the asymmetric current (diagram D) through circuit Ec and via electrodes 2 and 3 and electrolyte 14. The process electrolyte was typically selected to be electrically non-linear, in that its resistance varied non-linearly with changes in electrolysis voltage.

Because of the asymmetrical nature of the current and the non-linear nature of the electrolyte, the flow within the electrolysis circuit essentially contained direct current. The direction of this current was such as to make electrode 2 a cathode, which then facilitated some deposition of metals produced in the process onto the cathode. This deposition advantageously minimised or eliminated any wear/consumption of cathode 2 and thus maximised its life. In addition, the deposited metals were able to be periodically removed (eg. as a valuable product).

Process Electrolyte

The process electrolyte was preferably aluminium cryolite (Na₃AlF₆) however other solid electrolytes (such as lead cryolite, tantalum cryolite, mercury cryolite, BaO, SeO, PbO, TaO, HgO electrolytes etc) could be used. Generation of thermal energy was observed to be affected by the chemical make-up of the electrolyte. For example, the faster the movement of the molecules within the electrolyte, the higher the temperature of the electrolytic bath 2.

Initially the bath was heated by an external energy source to achieve a temperature at which the electrolyte melted. Na₃AlF₆ under normal conditions melted at a temperature of around 900° C., but this temperature was reduced by adding to the electrolyte fluorides of lithium, sodium, potassium or calcium. The molten cryolite was observed to dissolve aluminium oxide (Al₂O₃), which was one preferred electron stimulant added to ensure good bath conductivity of the electrolyte. To further increase the speed of molecules and temperature of the electrolyte (at a constant current) another type of electron activity stimulator was added. In one variation, zirconium dioxide (ZrO₂) was added as the electron activity stimulator.

The resulting electrolyte blend was observed to have a high capacity to emit electrons when heated, which increased its conductivity. This in turn substantially increased the amount of thermal energy produced for a constant input of electrical energy. The current in the electrolyte also enabled the transformation (nuclear synthesis) of both Al₂O₃ and ZrO₂ into other compounds, such that these compounds acted as a secondary fuel for the process.

A preferred electrode material was graphite, however the inventors also proved that, for a given consumption of electrical energy, a nickel-chromium electrode could also be used. Nickel-chromium was also observed to emit more thermal energy than a pure iron electrode. This was particularly so in an electrolyte containing ZrO₂ as primary fuel.

The inventors noted that ZrO₂ at room temperature had a simple wedge structure. At temperatures above 1250° C. it changed to a tetragonal structure. At temperatures around 1900° C. it changed to a hexagonal structure and at 2300° C. it changed into a cubic structure.

This was understood to result from a change of clusters as a result of a transfer of hydrogen atoms. The preferred synthesis reaction was as follows:

$$⇒ 2 α ⇒ 2 α \\ {Zr}_{40} + 2 {O}_{8} = {Kr}_{36} + 2 {Ne}_{10} + {W}_{1} = {Ge}_{32} + 2 {Mg }_{12} + {W}_{2} = {Ni}_{28} + 2 {Si}_{14} + {W}_{3} \qquad ( 1 )$$

In this equation W denotes energy released in the reaction and α symbolises 2 protons, so that 2α symbolises 4 protons.

The nickel and silicon thus formed (synthesised) had a cubic structure and this occurred at temperatures above 2300° C. The above reaction also produced metallised Kr36 and Ne10. These gases were metallised with metals such as copper, silver or gold, which metals produced super-conductive clusters. Similar reactions occurred with Al₂O₃ as follows:
Al₂O₃=Al₁₃+Al₁₃+30=Mg₁₂+Si₁₄+30+W₁=MgO+SiO₂+W₂ (2)

The inventors also noted that zirconium was related to calcium. Within the earth's crust, ZrO₂ is synthesised from CaO as follows:
Ca₂₀O+Ca₂₀O=Zr₄₀O2 (3)
Consequently, zirconium dioxide was referred to as double calcium oxide:
ZrO₂=(CaO)₂ (4)

When it was desirable to produce other species, and because of its nuclear instability, CaF₂ was instead added to the molten Na₂AlF₆ electrolyte, because CaF₂ was more active than CaO. At the same time, ZrO₂ (double calcium oxide) was observed to have a stronger electron activity than CaF₂. From a different perspective it was surmised that reaction (1) went through the following stages:
ZrO₂=CaO+CaO=Ni⁺ Ni=CaN+CaF=Co+Cu+W (5)

All stages of ZrO₂ transformation were usually accompanied by the release of thermal energy and substantial emission of electrons. Also, a wide range of elemental materials were able to be produced.

Multi-Phase Stimulation of Electrolysis Current

To enhance the synthesis reaction it was also desirable to increase the frequency of collisions of atoms, forcing them within the reach distance of nuclear forces, i.e. 10⁻¹³ cm. For a normal electric current the collision reactions were observed to be less frequent.

The present inventors therefore adopted measures to increase the complexity in the trajectory of ions (atoms). One way of increasing the probability of collisions was the use of multi-phase stimulation of current, resulting in trajectories similar to vortex cavitation. It was observed that an electrolyte affected by multi-phase current stimulation (ie. by 2 or more phases) swirled contemporaneously in eg. two counter flowing streams.

A number of techniques were employed to bring about the desired collision frequency, including the following:
1. Two phase stimulation using the Hall effect;
2. Three phase stimulation, using elements of the Hall effect.

Stimulated current was conveyed to the electrodes. After connection of the electrodes a Hall electrical force appeared that was associated with the curved trajectory of charged particles. If the electrodes were connected to consonant/harmonious potential current, the charged particles of the molten electrolyte did not move in the same direction, as the Hall effect was affected by gyration characteristics. Consequently, two counter flowing streams of particles were observed.

In the three-phase system an increased frequency of particle collisions was brought about through a cavitation effect.

Whilst the invention has been described with reference to a number of preferred embodiments, it will be appreciated that the invention can be embodied in many other forms.

1. A process for producing energy and elemental material by a nuclear synthesis reaction, including the steps of:
(i) introducing into an electrolysis cell a metal salt and a solid electrolyte which can be heated to a molten state; and
(ii) electrolysing the electrolyte to melt the same and to heat the metal salt such that atoms thereof synthesise to produce the elemental material and thereby generate energy.

2. A process as claimed in claim 1 wherein the metal salt is one or more of a lithium, sodium, calcium or zirconium salt.

3. A process as claimed in claim 2 wherein the metal salt is a metal fluoride salt.

4. A process as claimed in claim 2 or 3 wherein the electrolyte is cryolite (Na₂AlF₆).

5. A process as claimed in any one of claims 1 to 3 further including an electron stimulant.

6. A process as claimed in claim 5 wherein the electron stimulant is a metal oxide, nitride or sulphide.

7. A process as claimed in claim 6 wherein the metal oxide is one or both of an aluminium or zirconium oxide, and the metal nitrides or sulphides are one or more nitrides/sulphides of titanium, copper and iron.

8. A process as claimed in any one of claims 1 to 3, 6 or 7 wherein the current supplied to the electrolysis has an asymmetric configuration.

9. A process as claimed in claim 8 wherein the asymmetric current is produced in a power circuit incorporating a variable saturation inductor.

10. A process as claimed in claim 9 wherein the asymmetric current supplied to the electrolysis is phase stimulated using multi-phase stimulation.

11. A process as claimed in claim 10 wherein the multi-phase stimulation employs a magnetic field around the electrolysis cell and makes use of the Hall effect.

12. Apparatus for producing energy and elemental material by a nuclear synthesis reaction, including:
(i) an electrolysis cell in which a metal salt can be introduced and a solid electrolyte can be heated to a molten state; and
(ii) a current generator for providing current to the electrolysis cell to electrolyse and melt the electrolyte and to heat the metal salt such that atoms thereof can synthesise to produce the elemental material and thereby generate energy.

13. Apparatus as claimed in claim 12 wherein the cell includes a cathode bath in which the electrolyte is held and an anode member extending into the bath.

14. Apparatus as claimed in claim 13 wherein the metal salt is incorporated into the anode member.

15. Apparatus as claimed in claim 13 or 14 wherein the anode member has a heat exchange coil extending therethrough, for conducting energy generated in the form of heat to a fluid in the coil.

16. Apparatus as claimed in claims 13 or 14 wherein the cathode has a heat exchanger associated therewith, for conducting energy generated in the form of heat to a fluid in the heat exchanger.

17. Apparatus as claimed in claim 16 wherein the fluid is water which is heated to produce steam, which can then be fed to a turbine generator.

18. Apparatus as claimed in any one of claims 12, 13 or 14 wherein the current generator is a power circuit incorporating a variable saturation inductor that produces an asymmetric current for the electrolysis cell.

19. Apparatus as claimed in claim 18 wherein the asymmetric current supplied to the electrolysis is phase stimulated using multi-phase stimulation.

20. Apparatus as claimed in claim 19 wherein a magnetic field generator is located around the electrolysis cell to produce the multi-phase stimulation, making use of the Hall effect.

21. (Cancelled)

22. (Cancelled)

23. An elemental material and/or energy produced by the process of claim 1.

24. An elemental material and/or energy produced by the apparatus of claims 12 or 13.

25. Apparatus for producing energy and elemental material by a nuclear synthesis reaction, including:
(i) an electrolysis cell in which a metal salt can be introduced and a solid electrolyte can be heated to a molten state, the cell employing electrodes which are adapted for use with a molten electrolyte and metal salt; and
(ii) a current generator for providing an asymmetric current to the electrolysis cell to electrolyse and melt the electrolyte and to heat the metal salt such that atoms thereof can synthesise to produce the elemental material and thereby generate energy.

26. Apparatus as claimed in claim 25 wherein the cell includes a cathode bath in which the electrolyte is held and an anode member extending into the bath.
